(19) United States
(12) Patent Application Publication
(10) Pub. No.: US 2014/0059505 A1
(43) Pub. Date: Feb. 27, 2014

(54) METHOD FOR DESIGNING INTEGRATED CIRCUITS EMPLOYING CORRECT-BY-CONSTRUCTION PROGRESSIVE MODELING AND AN APPARATUS EMPLOYING THE METHOD

(71) Applicants: Gerard M. Blair, Bath, PA (US); Shirley V. Smith, Allentown, PA (US); James C. Parker, Zionsville, PA (US); Vishwas Rao, Breinigsville, PA (US); Joseph J. Jamann, Nazareth, PA (US); Bruce E. Zahn, Allentown, PA (US); Tammy L. Harkness, Barto, PA (US)

(72) Inventors: Gerard M. Blair, Bath, PA (US); Shirley V. Smith, Allentown, PA (US); James C. Parker, Zionsville, PA (US); Vishwas Rao, Breinigsville, PA (US); Joseph J. Jamann, Nazareth, PA (US); Bruce E. Zahn, Allentown, PA (US); Tammy L. Harkness, Barto, PA (US)

(73) Assignee: LSI Corporation, Milpitas, CA (US)

(21) Appl. No.: 13/592,169

(22) Filed: Aug. 22, 2012

(51) Int. Cl. G06F 17/50

(52) U.S. Cl. 716/108

(57) ABSTRACT

Methods of designing an integrated circuit and an apparatus for designing an integrated circuit are disclosed herein. In one embodiment, a method includes: (1) generating a block model of the integrated circuit according to a first timing budget, (2) developing a top level implementation of the integrated circuit according to the first timing budget, (3) determining a second timing budget for the integrated circuit based on the block model and (4) modifying the block model and the top level implementation employing the second timing budget to provide a progressive block model and a modified top level implementation.

### TECHNICAL FIELD

This application is directed, in general, to integrated circuits (ICs) and, more specifically, to designing ICs employing hierarchical design flows.

### BACKGROUND

Designers of ICs use electronic design automation (EDA) tools, a category of computer aided design (CAD) tools, to create a functional circuit design, including a register transfer logic (RTL) representation of the functional circuit design, synthesize a “netlist” from the RTL representation, and implement a layout from the netlist. Synthesis of the netlist and implementation of the layout involve simulating the operation of the circuit and determining where cells should be placed and where interconnects that couple the cells together should be routed. EDA tools allow designers to construct a circuit, simulate its performance, estimate its power consumption and area and predict its yield using a computer and without requiring the costly and lengthy process of fabrication. EDA tools are indispensable for designing modern ICs, particularly very-large-scale integrated circuits (VLSICs). For this reason, EDA tools are in wide use.

Multiple EDA tools may be used when designing an IC. To manage the combination of the EDA tools that are used to design an IC, design flows are typically used. One type of design flow supports a hierarchical design methodology that allows designers to address problems on the physical side of the design process between logic synthesis and the implementation process. Through early analysis and floor planning, designers can apply physical constraints to assist in controlling the initial implementations of an IC design. Floor planning involves planning for the placement of various components, such as hierarchical design components, inside an IC. With a hierarchical design flow, EDA tools can allow a designer to reduce the number of iterations between running P&R (Place and Route) and then returning to the register transfer level (RTL) and synthesis thereof. Current hierarchical design flows may be derived from two dominant design methodologies, top-down and bottom-up.

### SUMMARY

One aspect provides a method of designing an integrated circuit. In one embodiment the method includes: (1) generating a block model of the integrated circuit according to a first timing budget, (2) developing a top level implementation of the integrated circuit according to the first timing budget, (3) determining a second timing budget for the integrated circuit based on the block model and (4) modifying the block model and the top level implementation employing the second timing budget to provide a progressive block model and a modified top level implementation.

The disclosure also provides another embodiment of a method of designing an integrated circuit that includes: (1) employing a dominant top-down design implementation flow or a dominant bottom-up design implementation flow for designing the integrated circuit, (2) generating a renegotiated timing budget for the integrated circuit according to a controlled timing budget renegotiation and (3) generating both a modified top level implementation and a progressive block model for the integrated circuit based on the renegotiated timing budget.

In yet another aspect, the disclosure provides an integrated circuit design generator. In one embodiment, the integrated circuit design generator includes: (1) a hierarchical flow manager configured to determine a type of hierarchical design flow for generating an integrated circuit design and (2) a timing budgeter configured to provide a renegotiated timing budget for the hierarchical design flow according to a controlled timing budget renegotiation and to maintain the renegotiated timing budget for both top level implementations and block level implementations of the integrated circuit design.

### BRIEF DESCRIPTION

Reference is now made to the following descriptions taken in conjunction with the accompanying drawings, in which:

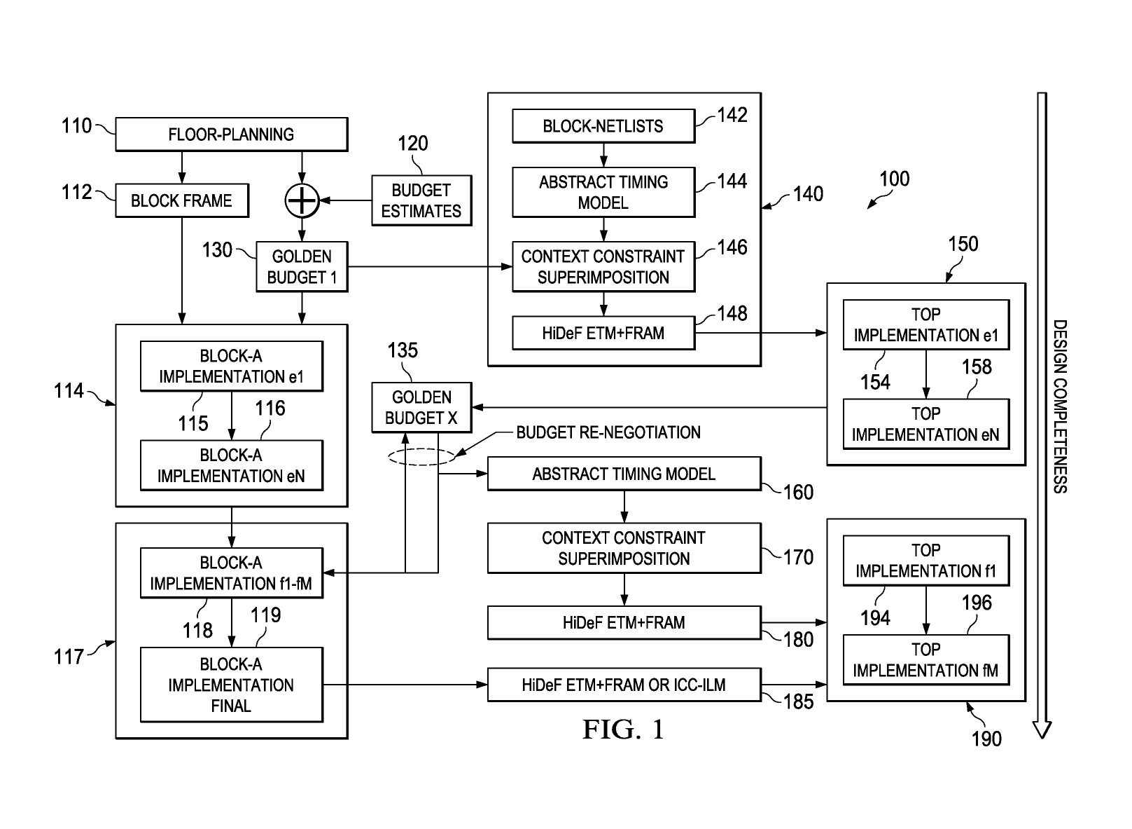

FIG. 1 illustrates a block diagram of an embodiment of a dominant top-down hierarchical design flow for designing an IC according to the principles of the disclosure;

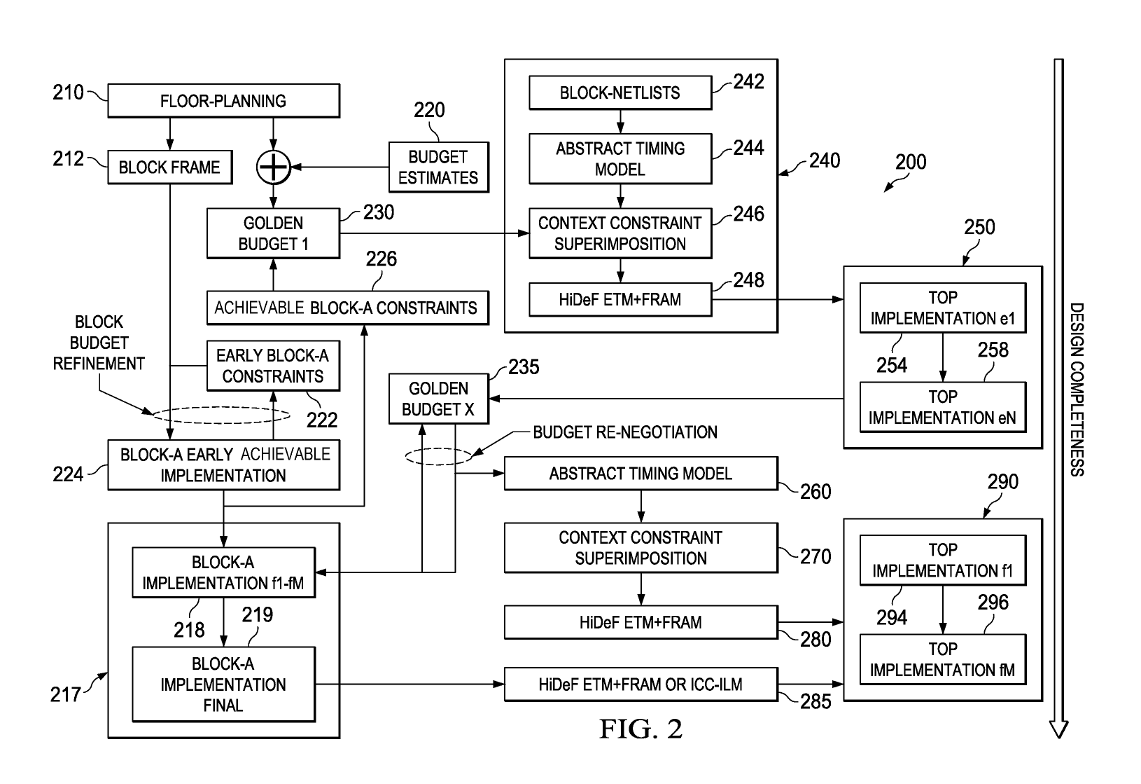

FIG. 2 illustrates a block diagram of an embodiment of a dominant bottom-up hierarchical design flow for designing an IC according to the principles of the disclosure;

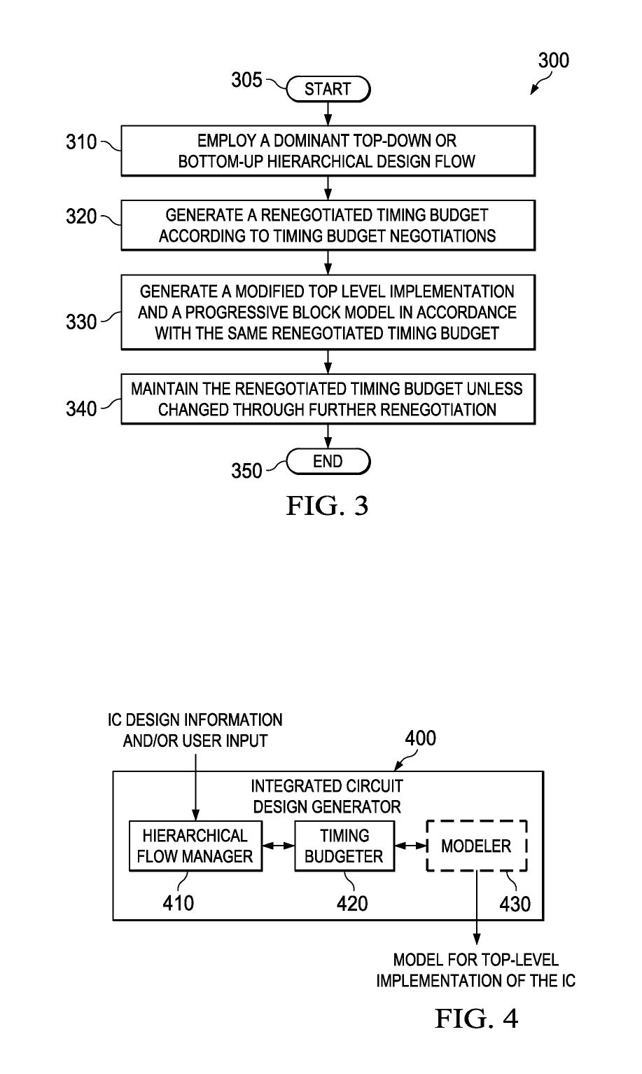

FIG. 3 illustrates an embodiment of a method 300 of designing an IC carried out according to the principles of the disclosure; and

FIG. 4 illustrates an embodiment of an integrated circuit design generator constructed according to the principles of the disclosure.

### DETAILED DESCRIPTION

Both of the current hierarchical design methodologies are susceptible to a timing “yo-yo effect” which can cause timing problems late in a design cycle, thereby jeopardizing the chip design schedule. The timing yo-yo effect can occur when extra interface timing slack in an immature block of a chip design is taken for the top level if an early block model is made visible during top level implementation. As the block implementation is being refined, the timing slack can be reclaimed for block level implementations. Thus, the supposedly available timing slack is mistakenly used for both top level implementations and block level implementations which typically cause timing closure problems late in the design cycle. This can be especially true when design teams are geographically distributed and logistics complicate the timing closure process.

Disclosed herein is a design flow process that employs a renegotiated timing budget that is used for different implementation levels or by designers for generating a circuit design. The renegotiated timing budget can be employed in both a top-down and a bottom-up hierarchical design flow. With a renegotiated timing budget, supposedly available timing slack from early block implementations can not be grabbed for top level implementations. Instead, the same renegotiated timing budget used for block implementations is provided to the higher levels of hierarchy during their implementation.

The renegotiated timing budget is maintained for top and block implementations. As disclosed in one embodiment, the renegotiated timing budget is changed through controlled renegotiations based on progressive block model implementations.

In one embodiment, the renegotiated timing budget is only changed when agreed upon by both top and block level designers. In some embodiments, a processor is configured to perform the controlled negotiations for the renegotiated timing budget.

The renegotiated timing budget includes a “frozen” block timing budget that is used for the block implementations. The frozen block timing budget is unchanged in view of the top level implementations unless changed through controlled renegotiations and provided in the renegotiated timing budget.

In one embodiment, the frozen block timing budget can be refined either when a block reaches the final stages of implementation, or if/when the interface timing needs to be re-adjusted. Timing re-adjustments across the top and block levels are therefore made in a tightly controlled manner.

The disclosure provides different hierarchical design flow embodiments that apply the progressive block modeling methodology disclosed herein. The different embodiments reflect the flexibility needed to accommodate the differences in maturity levels of blocks relative to the top level in practical hierarchical designs. An example of these differences can be seen in the design requirements for Application Specific Standard Parts (ASSPs) versus Application Specific Integrated Circuits (ASICs).

Generally, ASSP engagements have a tendency for blocks to evolve rapidly relative to the top level (dominant bottom-up), versus ASIC engagements where the customer generally presents the full chip (netlist or RTL) as a whole to the implementation team (dominant top-down). The illustrated embodiments of FIG. 1 and FIG. 2 represent the dominant top-down and bottom-up approach in hierarchical chip designs and address the impact of the yo-yo effect on timing closure. In both FIG. 1 and FIG. 2, top level and block level implementations progress to final implementations employing a renegotiated timing budget, wherein earlier implementations can use an initial timing budget. For example, in FIG. 1 late top level implementations of Top Level Implementations 190 employ the renegotiated timing budget (Golden Budget X 135 in FIG. 1) and Top Level Early Implementations 150 employ the initial timing budget (Golden Budget 130 in FIG. 1).

FIG. 1 illustrates a block diagram of an embodiment of a dominant top-down hierarchical design flow 100 for designing an IC according to the principles of the disclosure. The design flow 100 permits even distribution of available margin/slack between the top and the block level, recognizing the levels of maturity of the top level relative to the block level.

The design flow 100 includes Floor Planning 110, Timing Budget Estimates 120 and a Golden Timing Budget 130. The Floor Planning 110 involves planning for the placement of components or blocks of the IC design that are typically independently designed and placed together to form an IC such as a system-on-a-chip (SOC). The placement information of the IC design generated from the Floor Planning 110 provides timing information between components of the IC design. The Floor Planning 110 typically receives data from logic synthesis of the IC design generated from the RTL.

Timing Budget Estimates 120 provides timing information that may be provided by knowledge from a designer. Both the placement information and the manual timing information are provided to the Golden Timing Budget 130 and used thereby to generate input/output constraints for the IC design. The Golden Timing Budget 130 is considered an initial timing budget for the IC design.

The design flow 100 includes a Block Frame 112 that represents the functional blocks of the IC design that mature later or even simultaneously with the top level of the IC design. Block-A Implementations 114 (i.e., e1 . . . eN) represent block iterations going from a first early implementation, Block-A Implementation e1 115 to a final early implementation, Block-A Implementation eN 116. The input/output constraints from the Golden Timing Budget 130 are used to drive the Block-A Implementation 114. Block A is used to represent a single functional block of the IC design. One skilled in the art will understand that the design flow 100 may include multiple functional blocks of the IC design. As such, Block A may represent a plurality of functional blocks of the IC design that are moving towards final implementations.

The design flow 100 also includes a Hierarchical Modeling Flow 140 and Top Level Early Implementations 150 (i.e., e1 . . . eN). The Top Level Early Implementations 150 receive modeling information from the Hierarchical Modeling Flow 140 to drive the iterations thereof from a Top Early Implementation e1 154 to a final top early implementation, Top Early Implementation eN 158.

The Hierarchical Modeling Flow 140 generates a top level model for the IC design. The Golden Timing Budget 130 provides input/output constraints for the Hierarchical Modeling Flow 140 to drive the Top Level Early Implementations 150. Typically this is done in parallel with the Block-A Implementations 114. In addition to the input/output constraints from the Golden Timing Budget 130, the Hierarchical Modeling Flow 140 generates a Hierarchical Design Flow Model 148 employing Block-Netlists 142, an abstract timing model 144 from the Block-Netlists 142 and Context Constraint Superimposition 146 from the abstract timing model 144 and the Golden Timing Budget 130. The abstract timing model 144 is a timing model extracted from a netlist. In one embodiment, the abstract timing model 144 is generated in a different manner than a conventional Extracted Timing Model (ETM). An ETM is generated by reading a netlist into a commercial tool and generating the timing model. The resulting timing models typically do not contain detailed internal points/arcs that facilitate full-blown hierarchical analysis; the resulting timing models use short-cuts which can make constraint superimposition difficult later on in a design process. For example, if there is a CLK-input->OUTPUT-pin timing arc, an ETM will show it as one timing arc. However, with the abstract timing model 144, the CLK-input->OUTPUT-pin timing arc can be separated as two different arcs—CLK-input->INTERNAL-CLK-pin, and INTERNAL-CLK-pin->OUTPUT-pin. This allows separation of the clock-latency from the actual data-path and scalable hierarchical analysis later in the design flow through HiDeF modeling. U.S. patent application Ser. No. 12/905,301 entitled “A NOVEL MODELING APPROACH FOR TIMING CLOSURE IN HIERARCHICAL DESIGNS LEVERAGING THE SEPARATION OF HORIZONTAL AND VERTICAL ASPECTS OF THE DESIGN FLOW,” by Vishwas Rao, et al., filed on Oct. 15, 2010, which is incorporated herein by reference, provides an example of abstract timing models and generation thereof that may be employed herein.

The Context Constraint Superimposition 146 corresponds to changes for the abstract timing model 144 consequent upon the Golden Timing Budget 130. For example, from the Block-Netlists 142, such as the number of pins, their names and their dependencies on other pins, a timing model structure is derived, abstract timing model 144. The Golden Timing Budget 130 is then engaged to add numbers and values to the structure of the abstract timing model 144 that leads to the Hierarchical Design Flow (HiDeF) Model 148. The Hierarchical Design Flow Model 148 may be, for example, a timing model such as an ETM and a FRAM model. In another embodiment, the Hierarchical Design Flow Model 148 may be a Liberty model that allows modeling of generated clocks and internal clocks and a FRAM model.

The design flow 100 also includes a renegotiated timing budget 135. The renegotiated timing budget 135 is originally generated from the Golden Timing Budget 130 according to controlled timing budget renegotiations based on a frozen block timing budget employed for generating progressive block models of the IC design. As such, the renegotiated timing budget 135 is a modification of the original timing budget based on the progressive block models (i.e., the input/output timing interfaces of the progressive block models). In one embodiment, the renegotiated timing budget 135 is generated through controlled negotiations based on a difference between the frozen block timing budget for a block model, such as one of the final implementations, and the actual input/output timing of the block model. The renegotiated timing budget 135, represented by “Golden Budget X” is FIG. 1, is employed to prevent top level implementations from stealing supposedly available timing slack from block levels implementations. Instead, the renegotiated timing budget 135 provides an agreed upon timing budget for both top level and block level implementations to prevent or at least substantially lessen the yo-yo effect on timing closure. Additionally, the renegotiated timing budget 135 permits even distribution of available margin/slack between the top and the block level, recognizing the levels of maturity of the top level relative to the block level. As such, the design flow 100 recognizes that the top level of the design is more mature than the block level in the design flow and therefore initially drives the time budgeting.

Block-A Implementations 117 of the design flow 100 represent block iterations for a final block implementation and go from first block implementations, Block-A Implementation f1-fM 118 to a final block implementation, Block-A Implementation Final 119. The input/output constraints from the renegotiated timing budget 135 are used to drive the Block-A Implementations 117 to obtain the Block-A Implementation Final 119.

The input/output constraints from the renegotiated timing budget 135 are also used to drive generation of abstract timing model 160 which is used to generate new constraints for top level implementation in the Context Constraint Superimposition 170. Based on these new timing constraints, a Hierarchical Design Flow Model 180 is generated. The Hierarchical Design Flow Model 180 reflects the renegotiated timing budget 135 and also the maturity level of the block model implementations. As with the Hierarchical Design Flow Model 148, the Hierarchical Design Flow Model 180 may be a timing model such as an ETM and a FRAM model, a Liberty model and a FRAM model or a proprietary-type model that is employed for timing closure.

Additionally, a Finalized Block Model 185 is constructed. The Finalized Block Model 185 based on the Final Block Implementation 119. During the block iterations, all of the minor timing violations may be fixed. Additionally, the frozen block timing budget can be renegotiated with the top level of the hierarchical design model to generate the renegotiated timing budget 135. In addition, block iterations allow for ECOs (Engineering Change Orders). ECOs occur when functional verification (which is usually being run in parallel with the design implementation) detects bugs and corrections are made to the design to overcome those bugs. The renegotiated timing budget 135 is used to build the updated. Hierarchical Design Flow Models 180 to keep Top Level Implementations 190 (i.e., f1 . . . fM) of a top level section of the design flow 100 moving ahead through its final implementation iterations from a first late top implementation, Top Implementation f1 194 to a final top implementation, Top Implementation fM 196.

As the Top Level Implementations 190 converge towards final implementation Top Implementation fM, the expectation is that Block A is complete and a Finalized Block Model 185 is used to complete the Top Implementation fM 196. As illustrated, the Finalized Block Model 185 is obtained from the final block implementation, Block-A Implementation Final 119. The Finalized Block Model 185 may be an abstracted model that is generated by CAD tools. In one embodiment, the Finalized Block Model 185 may be timing model such as an ETM. In another embodiment, the Finalized Block Model 185 may be an Interface Logic Model (ILM) of an Integrated Circuit Compiler (ICC), such as an ICC CAD tool from Synopsis, Inc., of Mountain View, Calif. The Top Implementation fM 196 may then be used to construct the IC. In some embodiments, the Top Implementation fM 196 may be a GDSII file that is provided to an IC foundry for IC fabrication. GDSII is an acronym for the database file format Graphic Design System II stream format that is owned by Cadence Design Systems, Inc., of San Jose, Calif.

FIG. 2 illustrates a block diagram of an embodiment of a dominant bottom-up hierarchical design flow 200 for designing an IC according to the principles of the disclosure. The dominant bottom-up hierarchical design flow 200 represents blocks of an IC design that mature early in the IC design process. Block-A represents such early blocks. For example, in contrast to the dominant top-down hierarchical design flow 100 in FIG. 1, the design flow 200 includes an early achievable block implementation, Block-A Early Achievable Implementation 224, that is not present in FIG. 1.

The design flow 200 allows a higher proportion of the available margin/slack to be pushed to the top level, recognizing the fact that the top level is not as mature as the block in the design flow. At later stages, the available slack can be re-distributed as the top and block levels reach sufficient levels of maturity.

The design flow 200 includes Floor Planning 210, Timing Budget Estimates 220 and a Golden Timing Budget 230. The Floor Planning 210 involves planning for the placement of components or blocks of the IC design that are typically independently designed and placed together to form an IC such as a SOC. The placement information of the IC design generated from the Floor Planning 210 provides timing information between components of the IC design. The Floor Planning 210 typically receives data from logic synthesis of the IC design generated from the RTL.

Timing Budget Estimates 220 provides timing information that may be provided by knowledge from a designer. Both the placement information and the manual timing information are provided to the Golden Timing Budget 230 and used thereby to generate input/output constraints for the IC design. The Golden Timing Budget 230 is considered an initial timing budget for the IC design.

The design flow 200 includes a Block Frame 212 that represents the functional blocks of the IC design that mature later or even simultaneously with the top level of the IC design. The design flow 200 also includes Early Block-A Constraints 222 that are used for achieving the Block-A Early Achievable Implementation 224. The Early Block-A Constraints 222 can be provided from the Floor Planning 210 or may be obtained via constraints associated with a known block, such as, a block from a cell library. Early design iterations of the Early Block-A Achievable Implementation 224 establish Achievable Block-A Constraints 226 that provides information to the Golden Timing Budget 230. The Block-A Early Achievable Implementation 224 is provided to the Early Block-A Constraints 222 for analysis and updating. Accordingly, refining of the timing budget for Block-A can occur. This timing refinement for Block-A is performed without reference to the top level. As such, the block owner can self-impose stronger constraints upon their block and these can be given without negotiations in contrast to Achievable Block-A Constraints 226 and the Golden Timing Budget 230. This allows a block designer to refine an initial “bid” into the negotiation phase to provide a view of what is easily or reasonably achieved for a particular block. Though a block timing budget may include area and other constraints allocated therefor, herein the timing budget for a block, such as Block A, can be considered as the delays within that block of those paths that cross that block's boundary.

Block-A Early Achievable Implementation 224 is provided to the late design flow portion of Block A (e.g., Block A Implementation f1-fM 218). As such, each block of the design can be progressing asynchronously while the top level is progressing on its own. While the design flow is similar in each case, each block can be at a different stage of its own specific design flow (including the top level).

After the Block-A Early Achievable Implementation 222 is generated, Achievable Block-A Constraints 226 are obtained therefrom. These constraints are timing input/output constraints extracted from the Block-A Early Achievable Implementation 224. The Achievable Block-A Constraints 226 are supplied to the Golden Timing Budget 230. The Golden Timing budget 230 is modified by any outcome provided in the Achievable Block-A Constraints 226 to refine the context provided to Context Constraint Superimposition 246.

The design flow 200 also includes a Hierarchical Modeling Flow 240 and Top Level Early Implementations 250. The Top Level Early Implementations 250 (i.e., e1 . . . eN) receive modeling information from the Hierarchical Modeling Flow 240 to drive the iterations thereof from a top early implementation, Top Implementation e1 254 to a final top early implementation, Top Implementation eN 258.

The Hierarchical Modeling Flow 240 generates a top level model for the IC design. The Golden Timing Budget 130 provides input/output constraints for the Hierarchical Modeling Flow 240 to drive the Top Level Early Implementations 250. Typically this is done in parallel with progressive block modeling of the flow design 200. In addition to the input/output constraints from the Golden Timing Budget 230, the Hierarchical Modeling Flow 240 generates a Hierarchical Design Flow Model 248 employing Block-Netlists 242, an Abstract Timing Model 244 from the Block-Netlists 242 and Context Constraint Superimposition 246 from the Abstract Timing Model 244 and the Golden Timing Budget 230. The Hierarchical Design Flow Model 248 may be, for example, a timing model such as an ETM and a FRAM model or Liberty model and a FRAM model.

The design flow 200 also includes a renegotiated timing budget 235. The renegotiated timing budget 235 is originally generated from the Golden Timing Budget 230 according to controlled timing budget renegotiations based on a frozen block timing budget employed for generating progressive block models of the IC design. As such, the renegotiated timing budget 235 is a modification of the original timing budget based on the progressive block models (i.e., the input/output timing interfaces of the progressive block models). In one embodiment, the renegotiated timing budget 235 is generated through controlled negotiations based on a difference between the frozen block timing budget for a block model, such as one of the final implementations, and the actual input/output timing of the block model. The renegotiated timing budget 235, represented by “Golden Budget X” is FIG. 2, is employed to prevent top level implementations from stealing supposedly available timing slack from block levels implementations. Instead, the renegotiated timing budget 235 provides an agreed upon timing budget for both top level and block level implementations to prevent or at least substantially lessen the yo-yo effect on timing closure. Additionally, the renegotiated timing budget 235 allows a higher proportion of the available margin/slack from the block level to be pushed to the top level, recognizing the fact that the top level is not as mature relative to the blocks in the design flow 200. Thus, in contrast to the design flow 100, the design flow 200 recognizes the maturity at the block level and provides the initial context from the block level to create the golden budget.

Block-A Final Implementations 217 of the design flow 200 represent block iterations going from Block-A Implementation f1-fM 218 to a Block-A Implementation Final 219. The input/output constraints from the renegotiated timing budget 235 are used to drive the Block-A Final Implementations 217. The Block-A Implementation f1-fM 218 also receives the Block-A Early Achievable Implementation 224.

The input/output constraints from the renegotiated timing budget 235 are also used to drive generation of abstract timing model 260 which is used to generate new constraints for top level implementation in the Context Constraint Superimposition 270. Based on these new timing constraints, a Hierarchical Design Flow Model 280 is generated. The Hierarchical Design Flow Model 280 reflects the renegotiated timing budget 235 and also the maturity level of the block model implementations. As with the Hierarchical Design Flow Model 248, the Hierarchical Design Flow Model 280 may be a timing model such as an ETM and a FRAM model, a Liberty model and a FRAM model, proprietary-type model or another conventional model that is employed for timing closure.

Additionally, a Finalized Block Model 285 is constructed. The Finalized Block Model 285 is based on the Final Block Implementation, Block-A Implementation Final 219. During the block iterations, all of the minor timing violations may be fixed. Additionally, the frozen block timing budget can be renegotiated with the top level of the hierarchical design model to generate the renegotiated timing budget 235. In addition, block iterations allow for ECOs (Engineering Change Orders). ECOs occur when functional verification (which is usually being run in parallel with the design implementation) detects bugs and corrections are made to the design to overcome those bugs. The renegotiated timing budget 235 is used to build the updated Hierarchical Design Flow Model 280 to keep top level Implementations 290 of a top level section of the design flow 200 moving ahead through its final implementation iterations (i.e., f1 . . . fM) from a first late implementation, Top Implementation f1 294 to a final implementation, Top Implementation fM 296.

As the Top Level Implementations 290 converge towards the final implementation, the expectation is that Block A is complete and a Finalized Block Model 285 is used to complete the Top Level final implementation, Top Implementation fM 296. As illustrated, the Finalized Block Model 285 is obtained from the Block-A Implementation Final 219. The Finalized Block Model 285 may be an abstracted model that is generated by CAD tools. In one embodiment, the Finalized Block Model 285 may be a timing model such as an ETM. In another embodiment, the Finalized Block Model 285 may be an Interface Logic Model (ILM) of an Integrated Circuit Compiler (ICC), such as an ICC CAD tool from Synopsis, Inc., of Mountain View, Calif. The Top Implementation fM 296 may then be used to construct the IC. In some embodiments, the Top Implementation fM 296 may be a GDSII file that is provided to an IC foundry for IC fabrication. GDSII is an acronym for the database file format Graphic Design System II stream format. Other database file formats can also be used. For example, in one embodiment, Open Artwork System Interchange Standard (OASIS) can be employed.

FIG. 3 illustrates an embodiment of a method 300 of designing an IC carried out according to the principles of the disclosure. The method 300 may be performed by an apparatus and EDA tools. In one embodiment, the apparatus may direct the operation of EDA tools. In one embodiment, the apparatus may be a computer having the necessary circuitry (including a processor and memory) and/or software to perform (e.g., direct the operation of EDA tools). The method 300 begins in a step 305.

In a step 310, a dominant top-down design implementation flow or a dominant bottom-up design implementation flow is employed for designing an integrated circuit. In one embodiment, the design flow 100 is selected. In another embodiment, the design flow 200 is selected.

A renegotiated timing budget for the integrated circuit is generated in a step 320 according to a controlled timing budget negotiation. In one embodiment, the negotiation is between top level and block level implementations.

In a step 330, both a modified top level implementation and a progressive block model are generated for the integrated circuit in accordance with the same renegotiated timing budget. As such, stealing of purportedly available timing margin from block models is prevented.

The renegotiated timing budget is maintained in a step 340 unless changed through further renegotiation. In one embodiment, the renegotiated timing budget is only changed through renegotiations between top level and block level development or designers. Once agreed upon, then the renegotiated timing budget is provided for viewing and use by both the top level and the block level developers.

The method 300 then ends in a step 350.

FIG. 4 illustrates an embodiment of an integrated circuit design generator 400 constructed according to the principles of the disclosure. The integrated circuit design generator 400 may be a dedicated computing device that maintains a renegotiated timing budget in a design flow to prevent a timing yo-yo effect during timing closure. The integrated circuit design generator 400 may include the necessary circuitry to design an IC according to the methods and methodologies of FIGS. 1-3. In one embodiment, at least a portion of the integrated circuit design generator 400 may be embodied as a series of operating instructions stored on a non-transitory computer readable medium that directs the operation of a processor when initiated thereby. The integrated circuit design generator 400 may employ various EAD tools. The integrated circuit design generator 400 includes a hierarchical manager 410, a timing budgeter 420 and a modeler 430. As indicated by the dashed lines, the modeler 430 may be implemented separately from the hierarchical manager 410 and the timing budgeter 420.

The hierarchical manager 410 is configured to determine a type of hierarchical design flow for generating an integrated circuit design. The hierarchical manager 410 may include the necessary circuitry to select a hierarchical design flow according to design information received. A user may provide or enter design information whereupon the hierarchical manager 410 selects a particular design flow, such as a top-down or bottom-up hierarchical design flow. In one embodiment, the design flow of FIG. 1 is selected for use. In another embodiment, the design flow of FIG. 2 is selected.

The IC design information may be design requirements such as for an ASSP, an ASIC, or another type of chip. The IC design information can include, for example, a netlist, RTL, and targets for performance, power and area. In one embodiment, the hierarchical manager 410 receives user input via a user interface (keypad, microphone, keyboard, etc.) that indicates which type of hierarchical design flow to use.

The timing budgeter 420 is configured to provide a renegotiated timing budget for the hierarchical design flow according to a controlled timing budget renegotiation and maintain the renegotiated timing budget for both top level implementations and block level implementations of the integrated circuit design. The timing budgeter 420 may be configured to establish an original golden budget, renegotiate the budget based on progressive block models (e.g., final implementations of the block models) and establish the renegotiated timing budget according to the renegotiating. The timing budgeter 420 may be configured to receive timing budget information from a user with respect to a portion of an IC design. The timing budget information can include timing information for logic that is not presently being used in a block.

The modeler 430 is configured to develop a top level model of the IC design based on the renegotiated timing budget and block level implementations. The top level model can then be used to drive a top level implementation. The modeler 430 may iteratively develop the top level model. Both the timing budgeter 420 and the modeler 430 may employ or may include conventional EDA tools for performing their designated functions.

The above-described apparatuses and methods, or at least a portion thereof, may be embodied in or performed by various conventional digital data processors or computers, wherein the computers are programmed or store executable programs of sequences of software instructions to perform one or more of the steps of the methods, e.g., steps of the method of FIG. 3. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, e.g., one or more of the steps of the method of FIG. 3, or functions of the apparatuses described herein. Additionally, an apparatus, such as an EDA tool, may be designed to include the necessary circuitry to perform a step or steps of the method of FIG. 3.

Certain embodiments of the invention further relate to computer storage products with a non-transitory computer-readable medium that have program code thereon for performing various computer-implemented operations that embody the tools or carry out the steps of the methods set forth herein. Non-transitory used herein refers to all computer-readable media except for transitory, propagating signals.

The media and program code may be those specially designed and constructed for the purposes of the invention, or they may be of the kind well known and available to those having skill in the computer software arts. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

1. A method of designing an integrated circuit, comprising:
generating a block model of said integrated circuit according to a first timing budget;
developing a top level implementation of said integrated circuit according to said first timing budget;
determining a second timing budget for said integrated circuit based on said block model; and
modifying, by a processor, said block model and said top level implementation of said integrated circuit employing said second timing budget to provide a progressive block model and a modified top level implementation;
wherein said method is a non-partitioned design implementation flow for said integrated circuit.

2. The method as recited in claim 1, wherein said determining said second timing budget includes changing said first timing budget through a controlled renegotiation based on a difference between a block timing budget for said block model and an actual timing of said block model.

3. The method as recited in claim 1, wherein modifying said top level implementation includes modifying timing constraints for said top level implementation according to said second timing budget.

4. The method as recited in claim 1, wherein said modified top level implementation recognizes a maturity level of said progressive block model.

5. The method as recited in claim 1, wherein said progressive block model recognizes a maturity level of said modified top level implementation.

6. The method as recited in claim 1, wherein said determining said second timing budget includes distributing available margin or slack between said progressive block model and said modified top level implementation.

7. The method as recited in claim 1, wherein said method is a dominant top-down design implementation flow for said integrated circuit.

8. The method as recited in claim 1, wherein said method is a dominant bottom-up design implementation flow for said integrated circuit.

9. The method as recited in claim 1, further comprising constructing said integrated circuit based on said modified top level implementation.

10. The method as recited in claim 1, wherein said second timing budget includes a frozen block timing budget that is unchanged in view of said top level implementation.

11. A method of designing an integrated circuit comprising:
employing a single type of hierarchical design flow for designing said integrated circuit, wherein said single type being a dominant top-down design implementation flow or a dominant bottom-up design implementation flow;
generating a renegotiated timing budget for said integrated circuit according to a controlled timing budget renegotiation; and
generating, by a processor, both a modified top level implementation and a progressive block model for said integrated circuit based on said renegotiated timing budget.

12. The method as recited in claim 11, further comprising maintaining said renegotiated timing budget unless changed through further renegotiation.

13. The method as recited in claim 11, wherein said modified top level implementation is based on timing constraints generated from said renegotiated timing budget.

14. The method as recited in claim 11, wherein said modified top level implementation recognizes a maturity level of said progressive block model.

15. The method as recited in claim 11, wherein said progressive block model recognizes a maturity level of said modified top level implementation.

16. The method as recited in claim 11, wherein said renegotiated timing budget includes a distribution of available margin or slack between said progressive block model and said modified top level implementation.

17. The method as recited in claim 11, wherein said modified top level implementation is a final top level implementation and said method further comprises constructing said integrated circuit based on said final top level implementation.

18. An integrated circuit design generator, comprising:
a hierarchical flow manager configured to determine a single type of hierarchical design flow for generating an integrated circuit design; and
a timing budgeter configured to provide a renegotiated timing budget for said hierarchical design flow according to a controlled timing budget renegotiation and maintain said renegotiated timing budget for both top level implementations and block level implementations of said integrated circuit design.

19. The integrated circuit design generator as recited in claim 18, further comprising a modeler configured to develop a model for a top level implementation of said integrated circuit design based on said renegotiated timing budget and said block level implementations.

20. The integrated circuit design generator as recited in claim 18, wherein said hierarchical flow manager and said timing budgeter are further configured to interact with at least one EDA tool to perform its designated function.
